(19) United States
(12) Patent Application Publication
(10) Pub. No.: US 2010/0085895 A1
(43) Pub. Date: Apr. 8, 2010

(54) System and Method For Preparing And Exhibiting A Network Coverage Map

(75) Inventor: Gabor Bajko, Mountain View, CA (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/464,282

(22) Filed: May 12, 2009

Related U.S. Application Data
(60) Provisional application No. 61/052,587, filed on May 12, 2008.

(51) Int. Cl. H04W 24/00

(52) U.S. Cl. 370/254; 455/446

(57) ABSTRACT

Systems and methods by which network coverage in a specific area can be exhibited to a user of a mobile node. Information stored on an information server may be used in an application which is capable of exhibiting the network coverage in a specific area. The network coverage may be based, for example, on an operating carrier, a carrier and its roaming partners or on a specific type of network. The information stored on the information server can be downloaded by a mobile node, thereby permitting to observe the coverage area for a network type(s) in which the user is interested. The coverage information may be exhibited, for example, in the form of a visual coverage map.

### FIELD OF THE INVENTION

The present invention relates generally to the providing and use of coverage information for one or more networks. More particularly, the present invention relates to the determining of network coverage in an area and the exhibiting of the network coverage information, for one or more technologies, to a user.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Efforts have been made to provide standardized systems to enable the seamless handover of devices between networks. In particular, these efforts have focused on systems which not only enable the handover between networks of the same type, but also between enable handover between networks of entirely different types.

The Institute of Electrical and Electronics Engineers (IEEE) 802.21 is an emerging standard which is intended to provide guidelines for enabling, among other things, seamless handovers. Among other features, it is anticipated that IEEE 802.21 will enable roaming among various different types of networks, will be applicable to both wired and wireless networks, and will be compatible with other IEEE 802 standards.

When a connection is made with an individual network, a layer 2 link is formed between a node, such as a mobile node, and a point of attachment (PoA). A PoA may be a network point of service (PoS), which is a network-side media independent handover function (MIHF) instance that exchanges media independent handover (MIH) messages with a mobile node-based MIHF. A single PoS can host more than one MIH service. The same MIH Network Entity can include multiple MIH PoS's that can provide different combinations of MIH services to respective mobile nodes based on subscription or roaming conditions.

The coverage of an individual PoS may vary greatly, with such coverage depending on factors such as the radio technology being used, the network frequency, power level, etc. For example, a GSM base station's coverage may range from about 100 meters to up to about 30 kilometers. Similar variations can occur for WiMax base stations, code division multiple access (CDMA) base transceiver stations, etc. On the other hand, a base station under IEEE 802.11a/b/g is usually in the range of about 100 meters, while an IEEE 802.11n base station may have a range of up to about 250 meters.

### SUMMARY OF THE INVENTION

Various embodiments provide systems and methods by which network coverage in a specific area can be exhibited to a user of a mobile node. According to various embodiments, information stored on an IEEE 802.21 information server can be used in an application which is capable of exhibiting the network coverage in a specific area. The network coverage may be based, for example, on an operating carrier, a carrier and its roaming partners or on a specific type of network. The information stored on the information server can be downloaded by a mobile node, thereby permitting to observe the coverage area for a network type(s) in which the user is interested. This coverage information may be exhibited, for example, in the form of a visual coverage map.

These and other advantages and features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of an exemplary network model with MIH services according to various embodiments;

FIG. 2 is a flow chart showing a process by which various embodiments may be implemented;

FIG. 3 is a graphical representation of a network coverage map which may be exhibited to a user of a mobile node according to various embodiments;

FIG. 4 is a perspective view of an electronic device that can be used in conjunction with the implementation of various embodiments of the present invention; and

FIG. 5 is a schematic representation of the circuitry which may be included in the electronic device of FIG. 2.

### DETAILED DESCRIPTION OF VARIOUS EMBODIMENTS

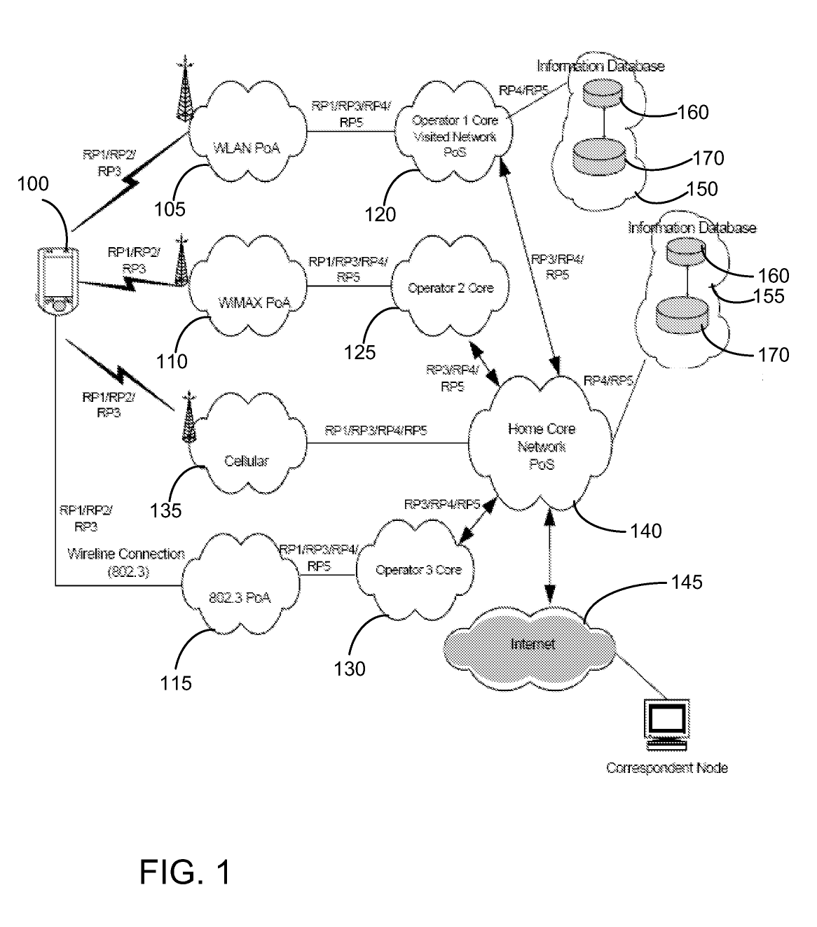

FIG. 1 is a representation of an exemplary network model with MIH services according to various embodiments. A mobile node 100 supports multiple wired and wireless access technologies. First, second and third access networks 105, 110 and 115 are operatively connected to first, second and third operator core networks 120, 125 and 130. A fourth access network 135 is also depicted as being more directly connected to a home core network 140. It is also possible for individual access networks to connect to a core network, such as the home core network 140, via the Internet 145. Each of the first, second and third core operator networks 120, 125 and 130 may represent a service provider, a corporate intranet provider, or another part of a visited network or home access network. At any given point in time, the subscriber's serving network may comprise a home subscriber network or a visited network. In the model depicted in FIG. 1, the first operator core network 120 is a visited network.

In the model of FIG. 1, the individual network providers offer MIH services in their respective access networks in order to facilitate heterogeneous handovers into their networks. Each access technology either advertises its MIH capability or responds to MIH service discovery. Each service provider for these access networks allows access to one or more MIH PoS nodes. The PoS nodes provide some or all of the MIH services as determined during the MIH capabilities discovery. The PoS location varies based on the operator deployment scenario and the technology-specific MIH architecture.

Also depicted in FIG. 1 are first and second information services 150 and 155. In the model depicted in FIG. 1, the first information service 150 is associated with the first core network 120, i.e., the visited network, while the second information service 155 is associated with the home core network 140. Each of the information services comprises an information database 160 and an information server 170.

Various embodiments provide systems and methods by which network coverage in a specific area can be exhibited to a user of a mobile node. According to various embodiments, information stored on an information server can be used to build an application which is capable of exhibiting the network coverage in a specific area. The network coverage may be based, for example, on an operating carrier, a carrier and its roaming partners or on a specific type of network. The information stored on the information server can be downloaded by a mobile node, thereby permitting a user and/or an application/software to observe the coverage area for a network type(s) in which the user is interested. This coverage information may be exhibited, for example, in the form of a visual coverage map.

The information in an IEEE 802.21 Information Server is intended to support handovers across various technologies. According to various embodiments, however, information from the Information Server may also be used for other purposes. For example, a parameter may be used to indicate a coverage range for a particular PoA. Such a PoA may comprise, for example, a Second or Third Generation Partnership Project base station, a WiFi access point, etc. In a particular embodiment, a “Coverage-Range” parameter may be included in a PoA-specific information element list, with this parameter specifying the coverage range in meters. For some PoA's, such as 802.11a/b/g base stations, the value for the “Coverage-Range” parameter may comprise a default value, e.g., the standard 100 meter value discussed previously. For PoA's which may have varying ranges, on the other hand, the proper value may be determined and configured using various methods. The “Coverage-Range” parameter may be included, for example, in a PoA container which contains information used to depict the PoA.

With coverage range information, detailed cellular or WiFi coverage information for a certain area is obtainable, and this information can be downloaded to the mobile node for use. An application on a mobile node may use this information in order to determine the precise network coverage for a single PoA. Alternatively, such an application may use this information to determine the network coverage for multiple PoA's, for example PoA's belonging to the same carrier or using the same technology, in a designated area. This can be particularly valuable to a user in a roaming context, since it is desirable for a user to be capable of learning about roaming and handover possibilities in a particular area.

The coverage range information which may be identified and provided according to various embodiments may provide the mobile node with improved information relative to conventional arrangements. For example, parameters have been conventionally used to indicate the radius of a neighborhood, centered at a particular location, within which all available access networks are included in a list of neighboring networks. One such parameter is referred to as “NGHB_RADIUS.” However, even if a precise location of the PoS is included, the mobile node cannot use the information to accurately determine if a PoS at a certain location has coverage across the entire area specified by this parameter, as there may only be coverage at the center of the area, at the perimeter of the area, etc. The coverage range information, on the other hand, provides a significantly more complete picture of the coverage around the PoS.

The coverage range information discussed above may be also be used by an application to develop a carrier or technology-based coverage map, thereby permitting a user of a mobile node to view a graphical representation of the coverage area. In the case of a carrier-based coverage map, such a map may display the coverage for base stations belonging to a specific carrier, for example based upon an operator identification or operator name. The map may alternatively be access/technology-specific, for example displaying coverage of all WiFi access points, regardless of the carrier(s). In yet another embodiment, the coverage map may be a combination of the carrier-specific and technology-specific implementations discussed above. The coverage map may also take roaming agreements into account in certain embodiments. For example, if a list of roaming partners is available, a coverage map can be generated such that each different roaming technology is represented differently, e.g., by different colors. This may be particularly useful in a situation where different roaming technologies have different pricing arrangements, etc.

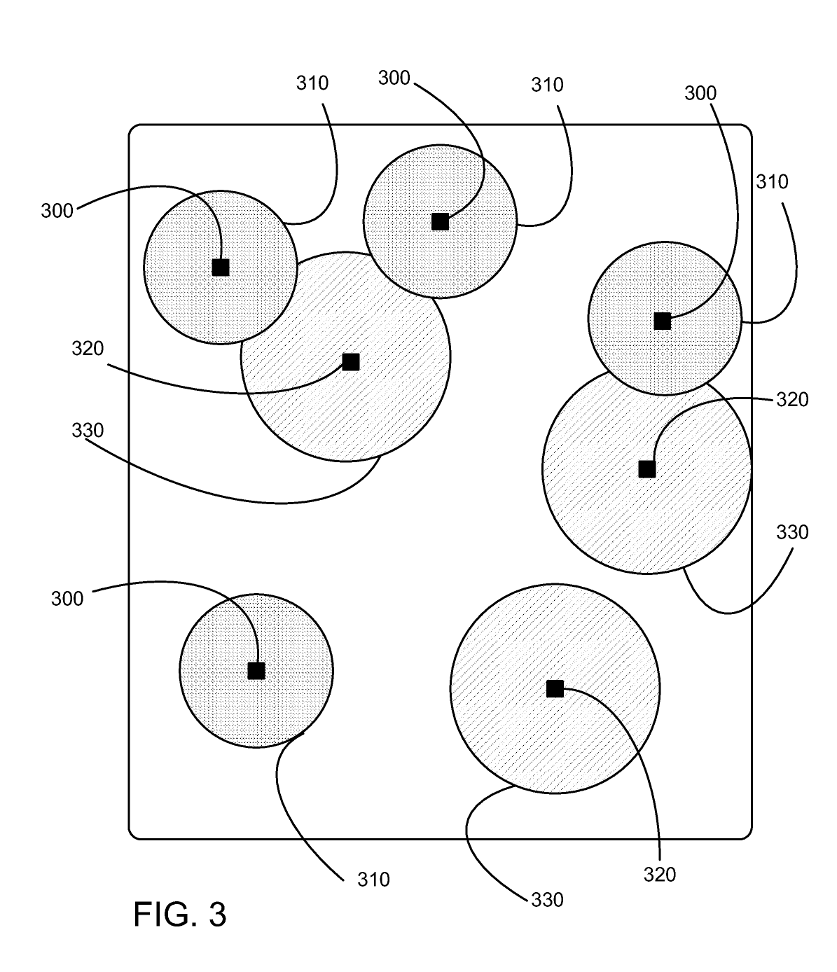

FIG. 3 is a depiction of an exemplary coverage map. In FIG. 3, a plurality of PoA's are shown, along with their respective coverage areas. In this example, a first set of GSM base stations are shown at 300 with their respective GSM coverage areas 310. Additionally a set of WiMax POA's 320 are also shown along with their respective WiMax coverage areas 330. As mentioned above, the precise information that is provided to the user may vary depending upon user and/or system specifications.

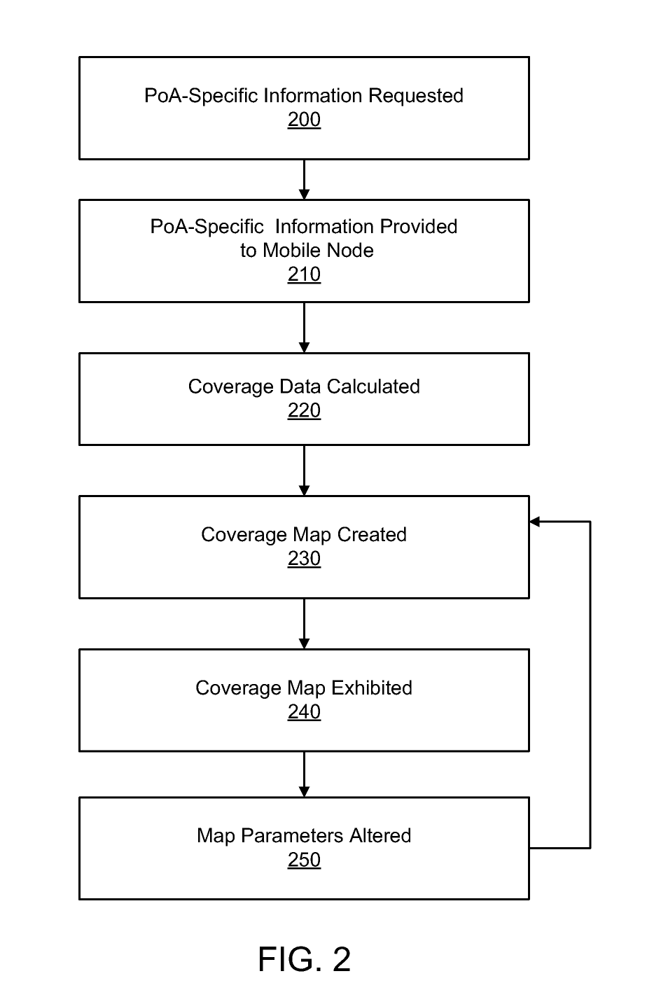

FIG. 2 is a flow chart showing an exemplary process by which various embodiments may be implemented. At 200 in FIG. 2, a mobile node requests PoA-specific information from an information server. This information may include, for example, information concerning the location of one or more PoA's, a PoA's link type, a PoA's operator ID, the PoA's coverage range, etc. The requested PoA-specific information is provided to the mobile node at 210. At 220, coverage data is calculated using the received PoA-specific information. At 230, an application creates a coverage map using the calculated coverage data, and this information is exhibited to a user at 240. At 250, the user may change the parameters of the coverage map, for example by switching from a carrier-based map to an access-based map. This causes the application to reorganize the information and exhibit a modified map as needed.

In the embodiment depicted in FIG. 2, the application which creates the coverage map is run on the mobile node. However, in other embodiments, the application may be located on the information server or on a different device other than both the mobile node and the application server. In the case where the application is located on the information server, the information server may use the PoA-specific information in its possession to create the coverage map, after which the coverage map may be provided to the mobile node. In the case where application is located on a device other than the application server or the mobile node, the PoA-specific information may first be provided to this other device, which then may create the coverage map before transmitting it to the mobile node.

Communication devices within which various embodiments may be implemented may communicate using various transmission technologies including, but not limited to, CDMA, GSM, Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

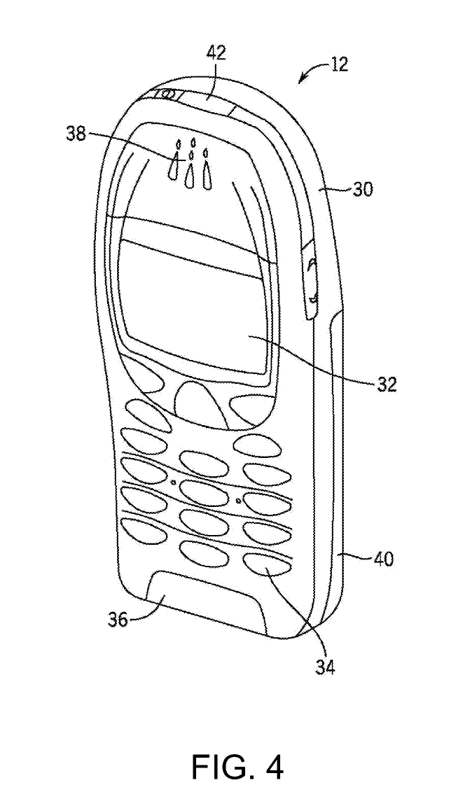

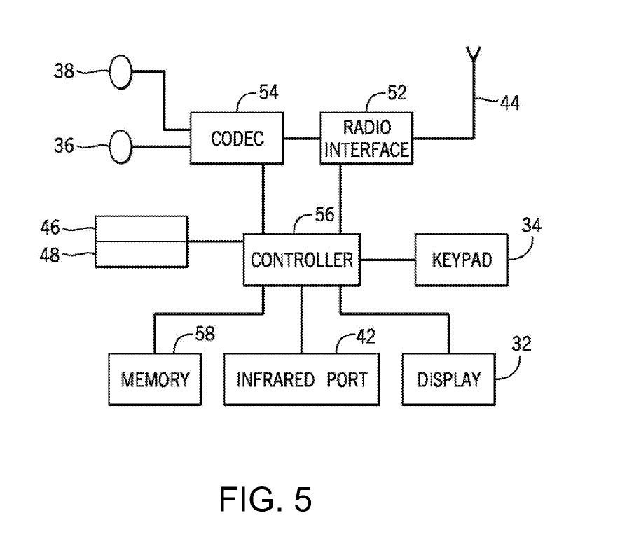

FIGS. 4 and 5 show one representative electronic device 12 within which the present invention may be implemented. It should be understood, however, that the present invention is not intended to be limited to one particular type of device. The electronic device 12 of FIGS. 4 and 5 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

Various embodiments provide a method, computer program product stored on a computer-readable storage medium, and apparatus for providing information concerning network coverage. Information is received from an information server, the information relating to a coverage range for at least one network point of attachment. A coverage map is created depicting network coverage for the at least one network point of attachment using the received information. The coverage map may be exhibited to a user. The coverage map may include a depiction network coverage for each network point of attachment in a geographic area corresponding to a particular carrier. The coverage map may include a depiction of network coverage for each network point of attachment in a geographic area which uses a particular technology. The coverage map may include a depiction of network coverage for all network point of attachments in a geographic area. Network coverage for a first technology may be depicted differently than network coverage for a second technology. Network coverage for a first carrier which requires roaming may be depicted differently than network coverage for a second carrier which does not require roaming. The information server may comprise an IEEE 802.21 information server.

Various embodiments also provide a method, computer program product stored on a computer-readable storage medium, and apparatus for providing information concerning network coverage. According to various embodiments, information relating to a coverage range for at least one network point of attachment is collected. The information is provided to a remote device for use in creating a coverage map depicting network coverage for the at least one network point of attachment. The information may be collected by an information server. The information server may comprise an IEEE 802.21 information server. The coverage range may be identified by distance.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
receiving information from an information server, the information relating to a coverage range for at least one network point of attachment; and
creating a coverage map depicting network coverage for the at least one network point of attachment using the received information.

2. The method of claim 1, further comprising:
exhibiting the coverage map to a user.

3. The method of claim 1, wherein the coverage map includes a depiction of network coverage for each network point of attachment in a geographic area corresponding to a particular carrier.

4. The method of claim 1, wherein the coverage map includes a depiction of network coverage for each network point of attachment in a geographic area which uses a particular technology.

5. The method of claim 1, wherein the coverage map includes a depiction of network coverage for all network point of attachments in a geographic area.

6. The method of claim 1, wherein the coverage map depicts network coverage for a first technology differently than network coverage for a second technology.

7. The method of claim 1, wherein the coverage map depicts network coverage for a first carrier which requires roaming differently than network coverage for a second carrier which does not require roaming.

8. The method of claim 1, wherein the information server comprises an IEEE 802.21 information server.

9. A computer program product, embodied in a computer-readable storage medium, comprising computer code configured to perform the processes of claim 1.

10. An apparatus, comprising:
a processor; and
a memory unit coupled to the processor, the memory unit including:
computer code for receiving information from an information server, the information relating to a coverage range for at least one network point of attachment; and
computer code for creating a coverage map depicting network coverage for the at least one network point of attachment using the received information.

11. The apparatus of claim 10, wherein the memory unit further includes:
computer code for exhibiting the coverage map to a user.

12. The apparatus of claim 10, wherein the coverage map includes a depiction of network coverage for each network point of attachment in a geographic area corresponding to a particular carrier.

13. The apparatus of claim 10, wherein the coverage map includes a depiction of network coverage for each network point of attachment in a geographic area which uses a particular technology.

14. The apparatus of claim 10, wherein the coverage map includes a depiction of network coverage for all network point of attachments in a geographic area.

15. The apparatus of claim 10, wherein the coverage map depicts network coverage for a first technology differently than network coverage for a second technology.

16. The apparatus of claim 10, wherein the coverage map depicts network coverage for a first carrier which requires roaming differently than network coverage for a second carrier which does not require roaming.

17. The apparatus of claim 10, wherein the information server comprises an IEEE 802.21 information server.

18. A method, comprising:
collecting information relating to a coverage range for at least one network point of attachment;
providing the collected information to a remote device for use in creating a coverage map depicting network coverage for the at least one network point of attachment.

19. The method of claim 18, wherein the information is collected by an information server.

20. The method of claim 19, wherein the information server comprises an IEEE 802.21 information server.

21. The method of claim 18, wherein the coverage range is identified by distance.

22. A computer program product, embodied in a computer-readable storage medium, comprising computer code configured to perform the processes of claim 18.

23. An apparatus, comprising:
a processor; and
a memory unit coupled to the processor, the memory unit including:
computer code for collecting information relating to a coverage range for at least one network point of attachment;
computer code for providing the collected information to a remote device for use in creating a coverage map depicting network coverage for the at least one network point of attachment.

24. The apparatus of claim 23, wherein the coverage range is identified by distance.
